(19) United States
(12) Patent Application Publication
(10) Pub. No.: US 2010/0125647 A1
(43) Pub. Date: May 20, 2010

(54) SYSTEM AND METHOD FOR LOCATION-SPECIFIC RESOURCE MANAGEMENT

(75) Inventors: Coty L. FOURNIER, Davie, FL (US); Craig D. NOBLE, Oakland Park, FL (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: Jobsite 123.Com, Inc.

(21) Appl. No.: 12/273,655

(22) Filed: Nov. 19, 2008

(51) Int. Cl. G06F 15/16

(52) U.S. Cl. 709/219

(57) ABSTRACT

The present invention provides a remotely accessible platform providing predetermined lists of industrial sector options, as well as tailored listings of vendors and/or service providers supplying such options. In particular, the present invention includes a system for facilitating resource identification and selection, including a server coupled to a communication network, the server including a list module having a predefined list of items and a vendor module generating a listing of a plurality of vendors supplying at least one item on the predefined list, where the listing of the plurality of vendors is generated based upon an identified location.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to resource management and more particularly to a user interface, system, and method for identifying, selecting and managing resources for multiple phases of or areas of a segmented industry.

### BACKGROUND OF THE INVENTION

Many commercial industries include various segments or operational areas providing services, products or resources to achieve a particular stage or task. One example of a generally segmented industry is that involving real estate. The real estate industry has several discrete, compartmentalized areas or segments having specialized or tailored services and products. For example, generally speaking, the real estate industry encompasses services and products for the identification of a particularly desirable parcel of land, the acquisition of the property, the development of the property, and the subsequent selling or management of that property.

Each segment or area of a compartmentalized industry further typically includes sub-categories for services and products in that particular area. For example, in the property development (or construction) arena of the real estate industry, the time may come to actually build a structure on a particular site (in addition to other related sub-categories, such a zoning & governmental relations, land surveying, site preparation, etc.). To do so often requires the selection, organization, and management of various firms, contractors, sub-contractors, material suppliers, workers, or other service providers to successfully complete a building project. For example, an architectural firm may produce the initial plans and/or schematics, and subsequently, one or more general contractors may proceed to obtain materials, and select one or more subcontractors to handle specialized portions of the schematics, such as electrical, plumbing, roofing, etc. While some large companies may have the capacity and capabilities to handle one or more large construction projects in their entirety without the need for outside/additional services or workers, this is a rarity in the construction industry.

Of course, the selection and organization of multiple service providers is a time consuming process, irrespective of the particular industry, and thus has often carries a significant cost to any given project or task. The increased time and costs involved is applicable not only to the completion of a project, but also to the selection, management, and integration of services needed for initiation of the task at hand.

For example, job site mobilization precedes the actual construction of a particular project, and often includes the setup of essential facilities and ensuring proper safeguards are in place before a single brick is laid. A typical jobsite often requires a trailer or some mobile workspace for a general contractor or superintendent to work out of. Further, it is often essential to place barriers or some secure structure such as a fence or bolstered swale around a perimeter of a particular jobsite. Of course, the setup of vital utilities such as water and electricity must often be completed to enable a construction crew and/or contractors to initiate their selected tasks.

While numerous jobsite mobilization service and/or product suppliers may be available for any particular construction location, unless a builder is already familiar with and/or routinely operates in a particular geographic region, it may be difficult to readily identify available service providers for a particular location. Moreover, numerous aspects of construction site mobilization are regulated at the municipal or city level, and may further include codified requirements at the county level of government. As such, not only is it often difficult and time consuming to simply identify and choose the needed services or products from available vendors, but the governmental guidelines and/or regulations may also vary widely, thereby greatly increasing the time and associated cost involved in completing a particular jobsite setup in accordance with the applicable governmental requirements.

These location-specific difficulties in identifying and recruiting the needed resources to complete a task apply not only to the construction sector of the real-estate industry, but further apply to numerous sectors having geographically-specific needs for the initiation or completion of a task. In view of the above, it is desirable to provide a resource management system which reduces the time and associated cost required to identify, select, organize, and integrate services and/or products essential for tasks or goals in particular arenas of compartmentalized commercial industries for a designated location.

### SUMMARY OF THE INVENTION

The present invention provides a resource management system which reduces the time and associated cost required to identify, select, organize, and integrate services and/or products essential for tasks or goals in particular arenas of compartmentalized commercial industries. In particular, a system for managing resources is provided having a server coupled to a communication network, the server including a plurality of industry segments identified for a particular industry; a plurality of subcategories attributed to each identified industry segment; a list module having a predefined list of options for each of the subcategories; and a vendor module generating a listing of a plurality of vendors supplying at least one item on the predefined list, where the listing of the plurality of vendors is generated based upon a designated location. The server may store one or more personalized user profiles; a personalized selection of one or more items on the predefined list is stored in correlation with the one or more user profiles; and the listing of the plurality of vendors may be limited to vendors supplying items in the personalized selection. The server may also store one or more vendor profiles.

The present invention also advantageously provides a centralized system and method of use thereof for identifying, selecting, organizing, and integrating services and/or products essential for construction site mobilization in accordance with varying governmental regulations.

In particular, the present invention includes a system for facilitating construction site mobilization, including a server coupled to a communication network, the server including a list module having a predefined list of construction site mobilization items, a vendor module generating a listing of a plurality of vendors supplying at least one item on the predefined list, and a utility/inspection module generating at least one of a listing of a plurality of utility providers and a listing of a plurality of governmental building departments, where at least one of the listing of the plurality of vendors, the listing of the plurality of governmental building departments, and the listing of utility providers is generated based upon a construction site location. The server may store one or more personalized user profiles, and a personalized selection of one or more items on the predefined list may be stored in correlation with the one or more user profiles. In addition, the listing of the plurality of vendors may be limited to vendors supplying items in the personalized selection, and the vendor module may be operable to compare two or more of the plurality of vendors. The vendor module may also include price discount opportunities, or other related special offers, for one or more of the plurality of vendors.

The present invention also includes a method for facilitating construction site mobilization, including identifying a location of a construction site; selecting one or more construction site mobilization options or resources from a predefined list; and generating a list of construction site mobilization vendors based at least in part upon the selection of construction site mobilization options and the identification of the location of the construction site. The method may also include generating a list of utility service providers based at least in part upon the selection of construction site mobilization options and the identification of the location of the construction site, and generating a list of governmental building departments based at least in part upon the identification of the location of the construction site. The method may also include comparing one or more attributes of the vendors on the generated list, and storing the selection of one or more construction site mobilization options, where the selection is stored in correlation with a unique user profile. A bid may be requested for a selected option from one or more of the vendors on the generated list, and the vendor contact information is automatically loaded into a standardized bid comparison sheet with suggested applicable items for consideration during the selection process.

The present invention also includes a method for facilitating construction site mobilization, including accessing a server through a communication network; communicating a location of a construction site to the server; selecting one or more construction site mobilization options or resources from a predefined list stored on the server; and generating at least one of a list of construction site mobilization vendors and a list of utility service providers on the server, the generation based at least in part upon the selection of construction site mobilization options and the location of the construction site.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an illustration of a system for identifying and managing resources constructed in accordance with the principles of the present invention;

FIG. 2 is an illustration of an exemplary industry and associated segments of the industry in accordance with the principles of the present invention;

FIG. 3 is a block diagram of a system for aiding construction site mobilization constructed in accordance with the principles of the present invention;

FIG. 4 is an embodiment of a predefined list of questions related to the jobsite mobilization process in accordance with the principles of the present invention;

FIG. 5 is an embodiment of an additional predefined list of questions related to the jobsite mobilization process in accordance with the principles of the present invention;

FIG. 6 is an embodiment of another predefined list of questions related to the jobsite mobilization process in accordance with the principles of the present invention; and

FIG. 7 is a flow chart of an exemplary method of operation of a system for identifying and managing resources constructed in accordance with the principles of the present invention.

### DETAILED DESCRIPTION OF THE INVENTION

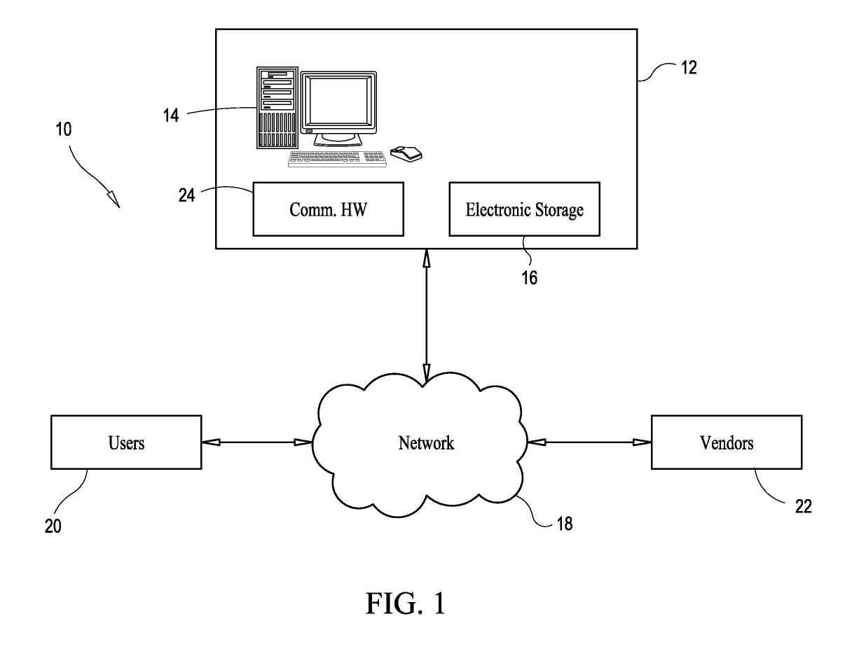

The present invention advantageously provides a centralized system and method of use thereof to identify, select, organize, and integrate services and/or products essential for tasks or goals in particular arenas of compartmentalized or fragmented commercial industries. Referring now to the drawing figures in which like reference designators refer to like elements, there is shown in FIG. 1, a resource management system constructed in accordance with the principles of the present invention and designated generally as “10”. The system 10 generally includes a service platform 12 accessible through a server 14, and including an electronic storage device 16 coupled to a communication network 18. In addition, the system 10 may include availability or connectivity to one or more users 20 as well as one or more vendors or service/product provider 22.

The service platform 12 may include one or more network servers 14 capable of hosting a web site, and one or more databases residing on the electronic storage device 16 containing information, products, and/or services related to the mobilization of a construction site. The databases may be located within the platform 12 but may also be located off-site or include a remote storage facility. The databases may include any known database system, such as a relational or object oriented database system, that can be programmed to support the data required for the features and methods described herein.

The term “server” as used herein refers to one more computers, network communication hardware 24 and any software stored thereon. The server 14 may store a variety of web pages that can be accessed by browser software on a remote terminal, as discussed in more detail below, and may include one or more personal computers, minicomputers, or mainframe computers, capable of offering data management, browser interactivity, network administration and security. The server 14 is operatively coupled to the network hardware 24 to establish communication across the communication network 18 with the users 20 and/or vendors 22. The network hardware 24 may consist of one or more processors that host a web site incorporating the features described herein as well as standard computer storage components such as Random Access Memory (RAM), Read Only Memory (ROM) and/or hard disk storage devices, as well as external memory devices such as compact disks, magnetic tape and the like.

The communication network 18 couples the network hardware 24, and thus the service platform 12, to the one or more users 20 and/or vendors 22, which may be at terminals, computers and/or other user interface device located remotely from the server and service platform. The communication network 18 may include a wired or wireless configuration, and may include the Internet or World Wide Web, but can also include an intranet, virtual network, or any network capable of communicating data between the users, vendors, and the network hardware of the service platform. The users and/or vendors may communicate with the service platform 12 via any type of known computers capable of supporting a web browser, such as Personal Computers (PCs), Personal Digital Assistants (PDAs), cell phones or an interactive television. The present invention is not limited by any particular physical communication device and can employ any device that provides interactive access to the communication network and thus the service platform.

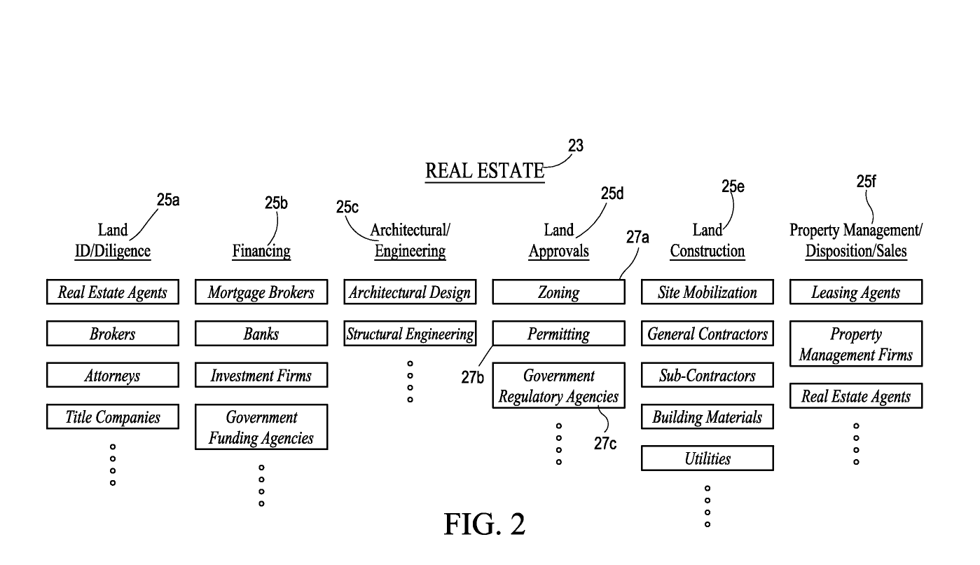

The server 14 of the present invention may generally include information, resources, and modules or tools for the identification, selection and management of resources in a particular segmented industry. Now referring to FIG. 2, an example of an industry 23, commercial or otherwise, having segmented or individualized areas, sectors or arenas of specialization 25a, 25b, 25c . . . etc (hereinafter collectively referred to as ‘25’) is shown. In this particular example, the real estate industry is shown, but the concepts and principles disclosed herein are equally applicable to numerous industries having discrete, compartmentalized areas of services/products. Continuing to refer to FIG. 2, the real estate industry 23 generally includes several areas 25 of specialized service/product providers for achieving particular goals or tasks within the industry. For example, the real estate industry includes a land-identification and diligence arena 25a; a financing sector 25b; an architectural/engineering arena 25c; an approvals stage or service sector 25d; a construction segment 25e; and a property management/disposition/sales division or sector 25f.

Each sector or area of specialization 25 includes several subcategories 27a, 27b, 27c . . . etc (hereinafter collectively referred to as ‘27’) of services or products within each sector 25. For example, the identification and diligence arena 25 of the real estate industry 23 may include subcategories 27 having real estate agents or brokers, attorneys, land title companies, etc. The financing sector 25 of the real estate industry 23 may include service/product providers such as mortgage brokers, banks, investment firms, governmental funding agencies, etc. The construction sector 25 may include subcategories, for example, such as site preparation, general contractors, subcontractors, material suppliers, of the like. Of course, these sectors and subcategories are merely illustrative, and can be defined in a myriad of different ways within the context of the present invention.

Each subcategory may further include information, listings, or the like for vendors or service/product providers for that particular subcategory. For example, the subcategory 27 of site mobilization and preparation for the construction sector 25 in the real estate industry may include vendors that put up security fences, install temporary trailers for workspace, provide utility installation or connection, etc. The construction sector 25 may further include subcategories or vendors in those subcategories organized according to, for example, codified divisions provided by the Construction Specifications Institute (“CSI Codes”).

The information regarding each industry 23, the defined sectors or areas 25 of each industry, the subcategories 27 for each sector, and the vendors associated with each category may reside on the server 14 within the system 10 of the present invention. The organization and accessibility of the information and modules of the server 14 of the system 10 is described in more detail as follows:

The system 10 may be accessed via the communication network 18 by the one or more users 20. User access 26 to the service platform 12 can be done anonymously or via a registered user profile. For example, upon accessing or otherwise connecting to the system, a user may create a user profile having a unique identifier and password, which may allow the ability to save and/or retrieve personalized or predefined settings for future use. The user profiles may be stored in the one or more databases of the service platform. Alternatively, a user may simply use the system anonymously, which might not include save and/or retrieve features associated with a unique, registered user profile. Of course, firewalls, data encryption and other hardware and software security measures that are well known in the art may be used to insure that unauthorized users cannot gain access to restricted or administrative portions of the server.

Once connected to the service platform through the use of a registered or anonymous profile, the service platform presents one or more industries available for selection, (e.g., real estate or the like). Selection of the desired industry 23 generates a predefined listing of sectors or particular areas 25 of service/product providers, as shown in FIG. 2. A user may then select the desired sector 25, and a predefined subcategory 27 correlated to the selected sector 25.

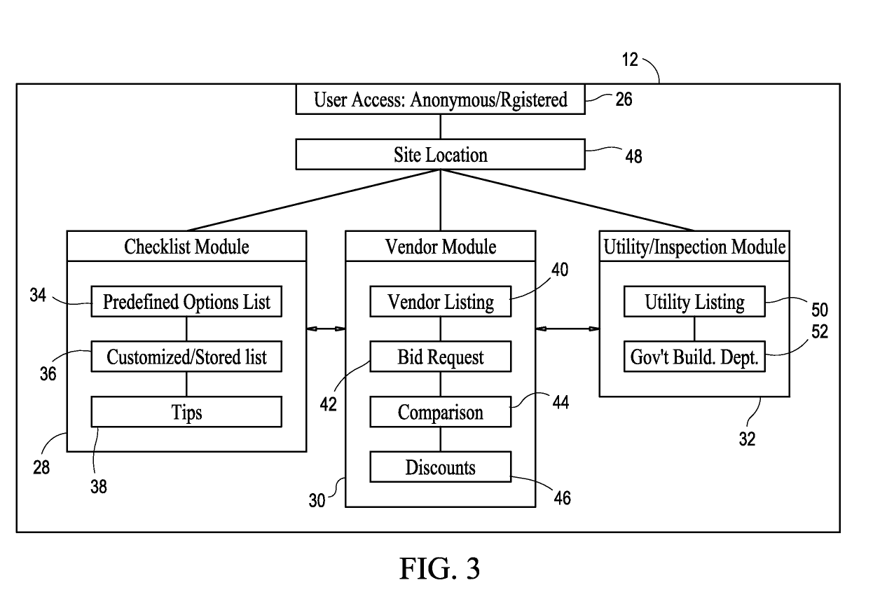

Now referring to FIG. 3, an organizational block diagram illustrating the components and functionality of the system 10 for selection or management of particular subcategory options. In this illustrative example, the subcategory of site preparation or mobilization is shown.

The system 10 includes three general components for identifying, selecting, organizing, and/or otherwise managing services and products for the mobilization of a construction site. In particular, the service platform may include a checklist module 28 identifying products and/or services typically needed for jobsite mobilization, a local supplier or vendor module 30 related to the applicable products/services, as well as a utilities and inspections module 32.

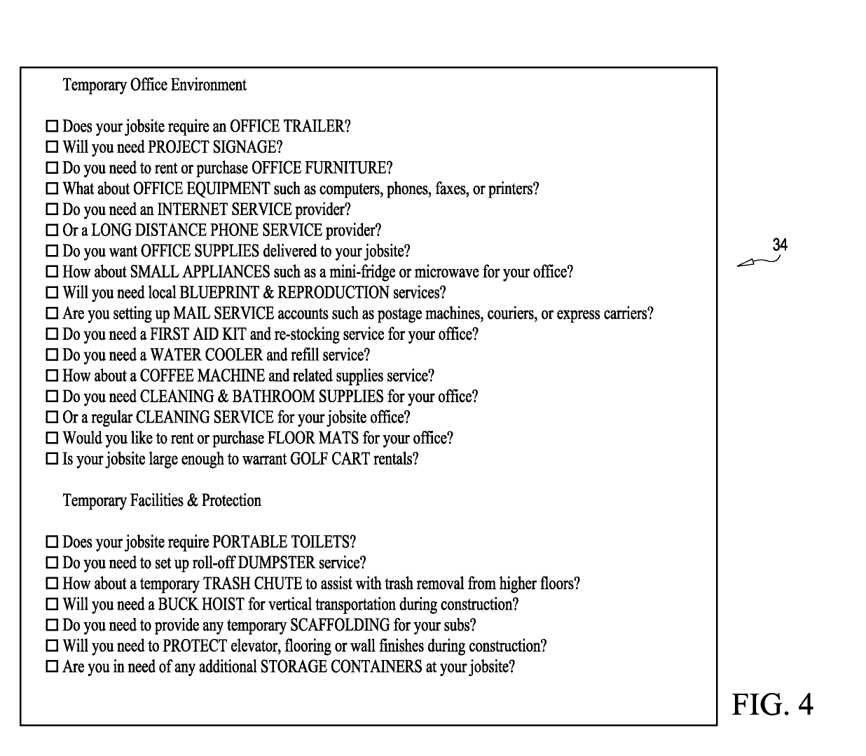

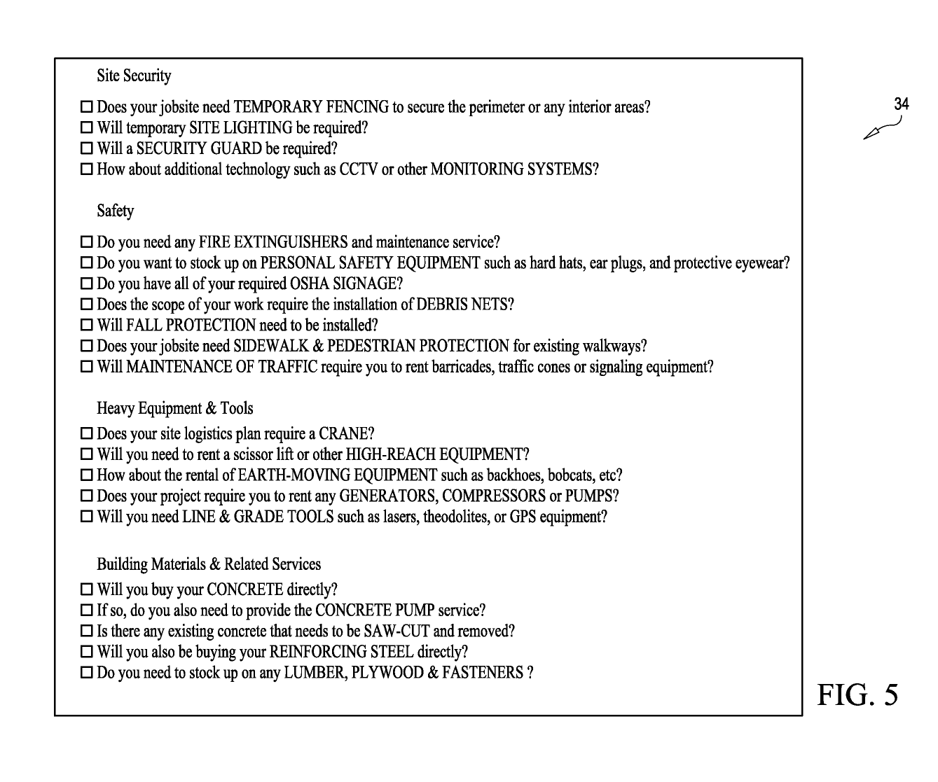

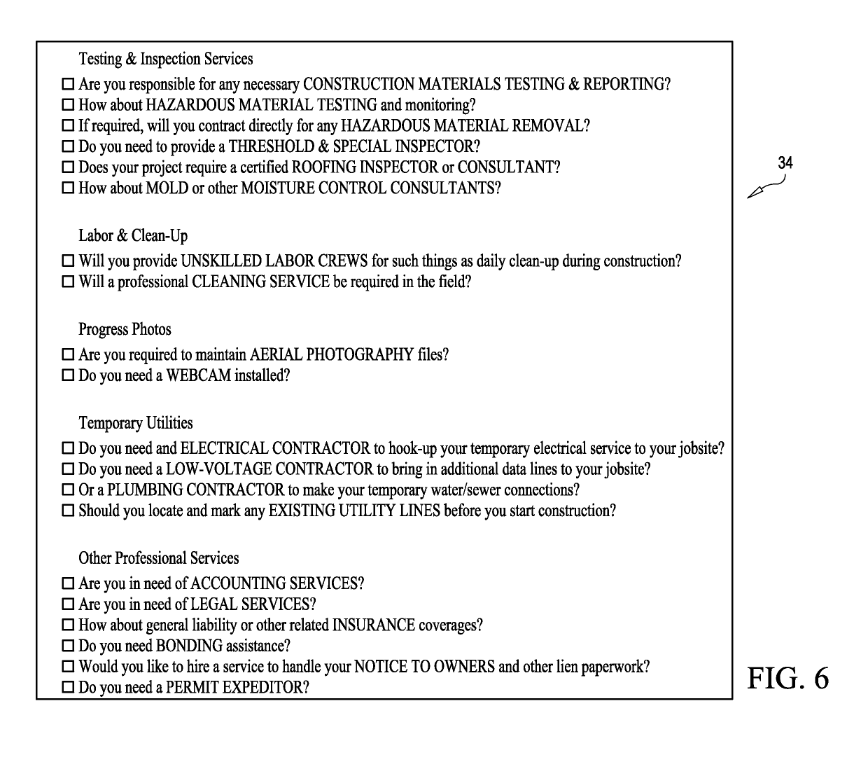

The checklist module 28 may generally include a predefined list 34 of facilities, products, and/or services typically needed for jobsite mobilization activities. For example, the predefined list 34 may include several general categories, as well as multiple services and/or products delineated under each categorical area. FIGS. 4-6 illustrate exemplary predefined lists of jobsite mobilization-related items, and include, but are not limited to, “Temporary Office Environment” (office trailers, project signage, office furniture, internet service provider, office supplies, etc.), “Temporary Facilities & Protection” (portable toilets, dumpsters, trash chutes, scaffolding, etc.), “Site Security” (temporary fencing, site lighting, security personnel, monitoring systems, etc.), “Safety” (fire extinguishers, personal safety equipment, OSHA signage, etc.), “Heavy Equipment & Tools” (cranes, high-reach equipment, earth-moving equipment, generators, etc.), “Building Materials & Related Services” (concrete, reinforcing steel, etc.), “Testing & Inspection Services” (hazardous material testing, threshold and special inspector, roofing inspector and consultant, etc.), “Labor & Clean-Up” (unskilled labor crews, cleaning services, etc.), “Progress Photos” (aerial photography, webcam, etc.), “Temporary Utilities”, “Other Professional Services” (accounting services, legal services, insurance, etc.). The above-described categories and products/services are merely illustrative of some content of the predefined list of jobsite mobilization items, as additional categories and related jobsite mobilization products, resources and services may also be included.

By providing a predefined list of services and/or products likely needed for pre-construction setup, the checklist module 28 gives users the ability to not only select which services or products they may need for a given project, but to also verify that no item has been overlooked or inadvertently omitted during the planning or selection stages prior to jobsite mobilization. Upon identification of the needed or desired items form the predefined list, selection of one or more of the listed items can be made. The selected items 36 can be saved or otherwise stored as a customized checklist or template for future use, should the case be that a general mobilization routine and accompanying services/products are repeatedly selected for a particular user or company, for example.

The checklist module 28 may further include additional content such as tips or professional advice 38 useful in navigating and proceeding through the construction site mobilization landscape, as well as including educational or other industry-related information relevant to the features, services, and/or products described herein.

Continuing to refer to FIG. 3, the vendor module 30 includes content and information related to the jobsite mobilization services/products, as described in the predefined list 34 for example, including a directory or listing 40 of applicable contact information and the like, a supplier bidding request function 42, as well as comparison and/or review forms 44 of selected vendors and any discounting specials or coupons 46. In particular, the vendor module 30 may include a plurality of listings for product/service providers, where the listings may be organized and/or accessible based on a geographic location 48 of a particular jobsite. Moreover, the vendor module 30 may be operably linked or otherwise in communication with the checklist module 28 such that identification of one or more services on the predefined list 34 may be used to generate a listing of those vendors or service providers in the vendor listings that provide the selected items or products. Upon identifying or otherwise selecting the desired vendors from the listings of the vendor module 30, whether by simply browsing the listings by topic, location, or other relevant query factors, or by narrowing down the vendor listings via the items selected from the predefined list 34 of the checklist module 28, the vendor module 30 may then facilitate a bidding process from the selected vendors. For example, upon selecting multiple vendors for a particular item or service, the “Bid Request” function 42 may be employed to submit site plans or other pertinent information to the selected vendors for the generation of a bid for service/products by the vendors. Subsequently, vendors may submit or otherwise communicate project bids for their particular service according to the received plans or information to the users of the system 10.

As mentioned, the vendor module 30 may also include a vendor comparison function 44, where information regarding selected vendors may be compared in a common view, and reviews and/or comments regarding particular vendors may be submitted and/or available to the users of the system. Further, any advertising specials, rebates, and/or discount coupons provided by the particular selected vendors may also be stored and available for access to the users of the system 10.

The utilities and inspections module 32 may generally include content and features directed towards typically essential jobsite utilities (e.g., electricity, water, communications, etc.), as well as data related towards applicable building inspection items, governmental regulations and contacts, and/or any other agencies having jurisdiction. Similar to the vendor module 30, the utilities and inspection module 32 may include a plurality of listings 50 for utility service providers (e.g., electric, water, phone, etc.), as well as listings 52 for governmental building departments (i.e., city, county, etc.), where the listings may be organized and/or accessible based on a geographic location of a particular jobsite. The listings generated may include contact information, profiles, reviews, hyperlinks, and/or any other pertinent information or characteristic attributes of the utility suppliers, and/or building departments needed or desired to aid in obtaining services and the like for the construction site setup. Moreover, the information and content of the utility module 32 may be operably linked or otherwise in communication with the checklist module 28 such that identification of one or more utilities and/or building inspection items on the predefined options list 34 may be used to generate a listing of those utility service providers that provide the selected items or products.

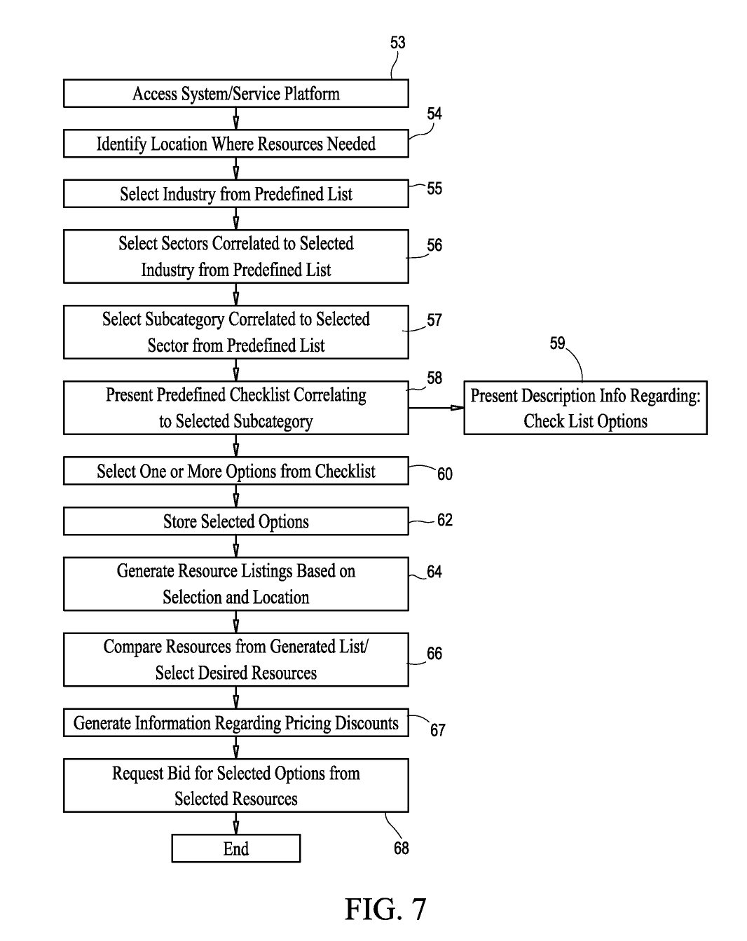

Now referring to FIG. 7, a flow chart of a method of operating a system for facilitating resource identification and selection is shown. Primarily, a user may access the server 14 and thus the service platform or system 10 through a communication network (Step 53). The access may include logging on through a registered, previously stored unique user profile, or as an anonymous user. A user may subsequently communicate or otherwise identify a location where services are needed (Step 54). The identification may include the entry of an exact street address, a zip code, or other similar geographical indicator (such as state, county or municipal information) sufficient to determine regionally located service/product providers, utility suppliers, and/or governmental entities able to service the designated location (or having regulatory power over the particular site for certain subcategories).

Once connected to the service platform, the user selects one or more industries available for selection from a predefined list, (e.g., real estate or the like) (Step 55). Selection of the desired industry generates a predefined listing of sectors or particular areas of service/product providers, as shown in FIG. 2. A user may then select the desired sector 25 (Step 56), and a predefined subcategory 27 (Step 57) correlated to the selected sector 25.

Once the location has been identified and the sectors and subcategories selected, the checklist module stored on the server may present a plurality of options for selection, including products and/or services typically needed or desired to complete or achieve a task associated with the subcategory (Step 58). In addition, informative descriptions and other educational or pertinent information regarding the particular mobilization options may be provided to guide or otherwise aid a user during their selection process (Step 59). One or more options may be selected from the list (Step 60), and subsequently, the selection may be stored in correlation with the unique user profile for later retrieval (Step 62), depending on the login scheme employed (e.g., registered user or anonymous).

The selection from the predefined list may then be communicated to either and/or both of the vendor module and the utilities and inspection module for generation of listings of one or more vendors and/or utility providers supplying one or more items selected from the predefined list (Step 64). The generated vendor and/or utility supplier listings may further be organized and/or otherwise narrowed to those suppliers and vendors servicing the regional or geographic area. Moreover, the utility/inspection module (in the particular site mobilization example) may generate a listing or identification of the particular municipal or governmental building department having regulatory power to inspect and/or otherwise enforce code requirements for a particular jobsite based upon the identification of the construction site location. As mentioned above, the listings generated may include contact information, profiles, reviews, hyperlinks, and/or any other pertinent information or characteristic attributes of the vendors, utility suppliers, and/or building departments needed or desired to aid in obtaining services and the like for the construction site setup.

Once the generated lists tailored to the selections made from the predefined options list and the identified location have been provided, one or more vendors may be compared or reviewed via the comparison function of the vendor module (Step 66). The comparison function may include a side-by-side presentation of attributes of two or more vendors so a determination or selection of a particular vendor best suited to provide the needed product or service can be made. Moreover, information regarding pricing discounts or opportunities may also be generated and/or presented when viewing the vendors or utility providers (Step 67). Subsequently to identifying one or more vendors for a desired product or service, a request for a bid to provide the particular selected option may be communicated to the vendor (Step 68), through the server for example. In the site mobilization example or for similarly technical subcategories, the bid request may also include schematics, plans or the like for the preparation of a specific quote for work or a specialized product/service. One or more vendors included on the vendor listings or databases of the server may have their own unique user profiles to enable the vendors to log on to the server and monitor any bid requests directed towards them.

By providing a centralized, remotely accessible platform providing predetermined lists of task-specific or subcategory resources, as well as tailored listings of vendors and/or service providers supplying such resources in a designated area, the time and associated cost typically involved in compiling such information from multiple sources and figuring whether or not certain suppliers are able to service the geographical area of the identified location is drastically reduced. The principles and concepts of the present invention as disclosed herein are readily applicable to a wide range of industries having particular sectors for service or products, including for example, product development (which may include sectors for prototyping, manufacturing, advertising, sales, etc.), and other compartmentalized industries.

The present invention can be realized in hardware, software, or a combination of hardware and software. An implementation of the method and system of the present invention can be realized in a centralized fashion in one computing system, or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product that comprises all the features enabling the implementation of the methods described herein, and which, when loaded in a computing system is able to carry out these methods. Storage medium refers to any volatile or non-volatile computer readable storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A system for managing resources, comprising:
a server coupled to a communication network, the server including
a plurality of industry segments identified for a particular industry;
a plurality of subcategories attributed to each identified industry segment;
a list module having a predefined list of options for each of the subcategories; and
a vendor module generating a listing of a plurality of vendors supplying at least one item on the predefined list, wherein the listing of the plurality of vendors is generated based upon a designated location.

2. The system according to claim 1, wherein the server stores one or more personalized user profiles.

3. The system according to claim 2, wherein a personalized selection of one or more items on the predefined list is stored in correlation with the one or more user profiles.

4. The system according to claim 3, wherein the listing of the plurality of vendors is limited to vendors supplying items in the personalized selection.

5. The system according to claim 1, wherein the server stores one or more vendor profiles.

6. A system for facilitating construction site mobilization, comprising:
a server coupled to a communication network, the server including
a list module having a predefined list of construction site mobilization items,
a vendor module generating a listing of a plurality of vendors supplying at least one item on the predefined list, and
a utility/inspection module generating at least one of a listing of a plurality of utility providers and a listing of a plurality of governmental building departments, wherein at least one of the listing of the plurality of vendors, the listing of the plurality of governmental building departments, and the listing of utility providers is generated based upon a construction site location.

7. The system according to claim 6, wherein the server stores one or more personalized user profiles.

8. The system according to claim 7, wherein a personalized selection of one or more items on the predefined list is stored in correlation with the one or more user profiles.

9. The system according to claim 8, wherein the listing of the plurality of vendors is limited to vendors supplying items in the personalized selection.

10. The system according to claim 6, wherein the vendor module is operable to compare two or more of the plurality of vendors.

11. The system according to claim 6, wherein the vendor module further includes discount information for one or more of the plurality of vendors.

12. A method for facilitating construction site mobilization, comprising:
identifying a location of a construction site;
selecting one or more construction site mobilization options from a predefined list; and
generating a list of construction site mobilization vendors based at least in part upon the selection of construction site mobilization options and the identification of the location of the construction site.

13. The method according to claim 12, further comprising generating a list of utility service providers based at least in part upon the identification of the location of the construction site.

14. The method according to claim 12, further comprising generating a list of governmental building departments based at least in part upon the identification of the location of the construction site.

15. The method according to claim 12, further comprising comparing one or more attributes of the vendors on the generated list.

16. The method according to claim 12, further comprising storing the selection of one or more construction site mobilization options.

17. The method according to claim 16, wherein the selection is stored in correlation with a unique user profile, the method further comprising retrieving the stored selection.

18. A method for facilitating construction site mobilization, comprising:
accessing a server through a communication network;
communicating a location of a construction site to the server;
selecting one or more construction site mobilization options from a predefined list stored on the server; and
generating at least one of a list of construction site mobilization vendors and a list of utility service providers on the server, the generation based at least in part upon the selection of construction site mobilization options and the location of the construction site.

19. The method according to claim 18, further comprising generating a list of governmental building departments based at least in part upon the identification of the location of the construction site.

20. The method according to claim 18, further comprising comparing one or more attributes of the vendors on the generated list.

21. The method according to claim 18, further comprising storing the selection of one or more construction site mobilization options on the server in correlation with a unique user profile, the method further comprising retrieving the stored selection from the server.
